(19) United States
(12) Patent Application Publication
(10) Pub. No.: US 2020/0083838 A1
(43) Pub. Date: Mar. 12, 2020

(54) Photovoltaic Panel Array and Method of Use

(71) Applicant: Barry Paul Sgarrella, Novato, CA (US)

(72) Inventor: Barry Paul Sgarrella, Novato, CA (US)

(21) Appl. No.: 16/598,559

(22) Filed: Oct. 10, 2019

Related U.S. Application Data
(63) Continuation-in-part of application No. 16/103,755, filed on Aug. 14, 2018.
Application No. 16/103,755 is a continuation-in-part of application No. 15/949,354, filed on Apr. 10, 2018.

(51) Int. Cl. H02S 20/32; A01G 13/02; G01W 1/12; G01W 1/06

(52) U.S. Cl. CPC H02S 20/32; A01G 13/0206; G01W 2203/00; G01W 1/06; G01W 1/12

(57) ABSTRACT

A method for “double cropping”, with photovoltaic panel arrays mounted on and operating from specialized photovoltaic solar array support structures that are supported above agricultural fields at heights that allow the passage of large mechanized farm equipment to pass beneath. The method of operation is optimized for sun sharing operation in that the solar array support structure and the solar panel array thereon is designed, spaced and computer positioned so as to optimize both the generation of electricity and the agricultural efficiency of the underlying land.

### PRIORITY

This application claims domestic priority to, and incorporates by reference herein the entire disclosure of U.S. Utility patent application Ser. No. 16/103,755, filed Aug. 14, 2018 and entitled “Photovoltaic Panel Array and Method of Use” which is a continuation-in-part patent application of U.S. Utility patent application Ser. No. 15/949,354, filed Apr. 10, 2018 and entitled “Photovoltaic Solar Array Support Structure.”

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to “double cropping” or “agrivoltaics” which are terms for electric power generation and optimization of agricultural crop growth on the same property. More particularly to photovoltaic panel arrays mounted on and operating from specialized photovoltaic solar array support structures and optimized for sun sharing operation above agricultural lands. This incorporates by reference U.S. patent application Ser. No. 15/949,354 titled “PHOTOVOLTAIC PANEL ARRAY SUPPORT STRUCTURE”, filed Apr. 10, 2018 by the same inventor and filed contemporaneously.

### BACKGROUND

Photovoltaic panels (solar panels) have come into widespread usage across the US, especially on the heels of government and utility tax incentives and rebates. With cost no longer a factor, the reality of real estate or space often becomes a deciding factor in their use. Since the majority of solar panels range from 14% to 16% efficiency rating, (with a maximum of about 22%) there is a large number of solar panels and a massive amount of planar surface area that is necessary to generate a substantial amount of electricity. In the way of an example, a typical single solar panel occupies 17.6 square feet and has a maximum output between 400 and 485 watts. Taking daylight into consideration the average daily output per solar panel is about 1 kWh. The average home in the US uses about 1,000 kWh of electricity per month. Thus, it takes about 600 sq. feet of solar panel surface to power a house. With their supporting structures, this is about all most homes can accommodate on their roofs.

The future of practical electrical generation with solar panels is in large arrays. These large arrays are not well suited for placement on high cost urban property because of their low power generation to area ratio and their propensity to cast a huge shadow. Besides, rooftops and building walls present a plethora of problems including poor aesthetics, high reflection, poor light transmission below (due to the tight cropping of solar panels), hazardous rain shedding, loss of visibility and the safety of those below.

The ideal rural siting would be on flat terrain, close to urban centers, where wildlife and wildfire damage is minimized, away from environmentally sensitive areas, away from extreme temperatures and near transmission systems. The problem herein is that such locations are generally developed for agricultural use.

Henceforth, a non-agriculturally intrusive large-scale photovoltaic panel array rurally sited that can coexist and even enhance the growth of farmed crops beneath coupled with a non-intrusive method of installation, would fulfill a long-felt need in the solar energy industry. This new invention utilizes and combines known and new technologies in a unique and novel configuration that accomplishes this.

### BRIEF SUMMARY

In accordance with various embodiments, a photovoltaic panel array that may be operated at an elevated height above agricultural land, provide both adequate sunlight and shading for the efficient growth of crops beneath the array is provided.

In one aspect, a photovoltaic panel array supported on a raised horizontal platform that has a negligible footprint and that can both generate electricity and retain or increase the agricultural efficiency of the underlying land.

In another aspect, a photovoltaic panel array customizable for the underlying crop, the geological siting and the meteorological conditions so as to generate electricity while optimizing the agricultural production beneath and allowing unhampered, ongoing farming activities in the area directly below the panel array, including the use of large mechanized farm equipment.

In yet another aspect, a photovoltaic panel array capable of sun sharing with underlying crops through a static, spaced configuration of solar panels that may be partially translucent, transparent or slotted so as to enhance the growth of crops by reducing the irrigation needs and crop evapotranspiration.

In yet another aspect, a photovoltaic panel array capable of sun sharing with underlying crops through a dynamic computerized, motorized “counter tracking” movement of the solar panels determined through an algorithm based on the sun position sidereal, and that is customized for that site, the spacing of the solar panels and the opacity (sun blocking) of the specific solar panels, as well as and the specific crops, growing season, irrigation systems, and underlying field maintenance schedules, so as to enhance the growth of crops by providing adequate sunlight for crop growth and reducing crop evapotranspiration.

In another aspect, the use of panels configured such that, when used in a static array, are sufficiently transparent to a quantity and wavelengths of sunlight to facilitate or optimize growth of crops below plus reducing irrigation requirements by providing a framework to support more efficient irrigation, providing intervals of partial shade that reduce the evapotranspiration in the growing cycle that reduces water requirements by approximately 19% to 24%.

In yet another aspect, a photovoltaic panel array that allows the passage of ample sunlight to the ground beneath the solar panel array for agricultural purposes and that reduces the amount of irrigation water needed for crop growth while producing photovoltaic energy, is provided.

Lastly, this invention enables the dual use of cropland for growing crops and for generating electricity by using panels that allow a certain quantity of sunlight to penetrate through them or past them to the cropland below.

Various modifications and additions can be made to the embodiments discussed without departing from the scope of the invention. For example, while the embodiments described above refer to particular features, the scope of this invention also includes embodiments having different combination of features and embodiments that do not include all of the above described features or all of the steps detailed in the methodology for practicing this system.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a side view of a photovoltaic panel array in its typical solar noon lowered position;

FIG. 2 is a side view of a photovoltaic panel array in its typical raised position;

FIG. 3 is a front perspective view of a sun sharing solar panel:

FIGS. 4A and 4B are top views of alternate embodiment sun sharing solar panels;

FIG. 5 is a top view of a static solar panel array;

FIG. 6 is a top perspective of a dynamic counter tracking solar panel array;

FIG. 7 is a rear view of a dynamic counter tracking solar panel array;

FIG. 8 is a top perspective view of a static solar panel array;

FIG. 9 is a schematic representation of the data acquisition computer's input and output signals;

FIG. 10 is a side view of a typical photovoltaic solar array and its operational components affixed to its support structure;

FIG. 11 is an illustrative schematic of the solar array's power system; and

FIG. 12 is a side view representative illustration of the alternate embodiment platform.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the terms “photovoltaic panel”, “solar panel” and “panel” all refer to the same thing—a grouping of photovoltaic cells arranged in a generally planar panel enclosure for the photovoltaic generation of electricity.

As used herein, the terms “photovoltaic panel array”, “panel array” and “array” refers to a grouping of solar panels and their associated operational equipment all arranged on a support structure.

As used herein, the term “sun sharing” refers to a static design or a dynamic movement of the overlying solar panel arrays that allows adequate sunlight to filter through, around or past the solar panels so as to reach the crops beneath the solar panel array.

As used herein, the term “sun shading” refers to a static design or a dynamic movement of the overlying solar panel arrays that allows adequate shading from direct sunlight for the crops beneath the solar panel array so as to reduce the amount of the crop's evapotranspiration and reduce sun damage to the crops from excess solar radiation.

As used herein, the term “counter tracking” refers to a dynamic, motorized movement of the overlying solar panels to accomplish the balance of “sun sharing” and “sun shading” for the crops beneath, as dictated by algorithmic instructions performed by the data acquisition computer's specific counter tracking program. The counter tracking program analyzes signals from environmental sensors in conjunction with the sun's location and directs the data acquisition computer to generate signals to operate the solar panel horizontal positional motors and the optional vertical rotational motors. The counter tracking program is customized to optimize crop growth for a specific crop and location.

As used herein, the term “counter tracking program” is a set of instructions optimized for a specific crop and location that are stored in non-volatile memory of a general-purpose computer and that directs this computer to generate drive signals for solar panel positional motors based on algorithmic analysis of signals from environmental wind strength and sun intensity sensors, tactile input devices, internet data and sidereal sun tracking position information.

As used herein the term “data acquisition computer” refers to a general-purpose computing device including a real time clock and memory that is capable of performing the algorithmic instructions stored in its non-volatile memory. These instructions take real time input digital data from environmental sensors and other data inputs such as internet weather predictions, and convert them into a format that can be analyzed in conjunction with the sun's movement (position) as determined by a sidereal tracking algorithm. Higher level instructions allow for the analyses of this real time input digital data as it relates to the specific crop's counter tracking program, allowing for the generation of a drive signal provided to the solar panel positional motors. It has a tactile input interface for the input of data and instruction sets.

As used herein, the term “translucent” when referring to solar panel components, means that all or some wavelengths of sunlight may pass through that component with minimal attenuation, although that component may not appear to be clear or transparent to the human eye.

In general, embodiments can employ as a data acquisition computer a processor, any device or combination of devices, that can operate to execute instructions to perform functions as described herein. Merely by way of example, and without limitation, any microprocessor can be used as a processor, including without limitation one or more complex instruction set computing (CISC) microprocessors, such as the single core and multi-core processors available from Intel Corporation™ and others, such as Intel's X86 platform, including, e.g., the Pentium™, Core™, and Xeon™ lines of processors. Additionally, and/or alternatively, reduced instruction set computing (RISC) microprocessors, such as the Raspberry Pi™ line of processors, processors employing chip designs by ARM Holdings™, and others can be used in many embodiments. In further embodiments, a processor might be a microcontroller, embedded processor, embedded system, system on a chip (SoC) or the like.

As used herein, the term “processor” can mean a single processor or processor core (of any type) or a plurality of processors or processor cores (again, of any type) operating individually or in concert. The functionality described herein can be allocated among the various processors or processor cores as needed for specific implementations. Thus, it should be noted that, while various examples of processors may be described herein for illustrative purposes, these examples should not be considered limiting.

The present invention relates to a novel design for a photovoltaic panel array mounted on a support structure on agricultural lands elevated high enough to allow the unhampered passage and use of sizeable machinery below. The large-scale solar panel array operates to allow enough sunlight and rain to pass through, around and by the solar panels in the array for conducting efficient agricultural activities directly beneath. This is accomplished through any combination of several innovative elements including partially transparent, translucent or slotted panels, optimized panel spacing, and a counter tracking computerized, motorized solar panel movement, timed to achieve a balance of optimized crop growth and electrical power generation based on a plethora of changing environmental and crop-based input parameters that are algorithmically calculated to accomplish this end result.

This photovoltaic panel array allows solar power to be produced on farmland while sustaining and often improving the quality of the crops produced. This is accomplished using a unique method of controlling the tracking algorithms that drive the positioning of single-axis tracking photovoltaic panel arrays to share sunlight with crops (Sun Sharing) at optimal times of day to produce solar power while allowing sufficient sunlight to pass by and/or through the solar arrays to the crops that are being grown beneath the solar arrays.

The photovoltaic panel arrays are built at a sufficient height above ground to allow conventional mechanized farming equipment (tractors, combines, harvesters) or robotic travelers to tend crops without interference. By controlling the horizontal positioning of the photovoltaic panel arrays for various intervals of time during the solar day, the sunlight can bypass the panels that are set in a Counter Tracking mode so the wide surfaces of the panels are parallel to the sunlight flow thereby not blocking sunlight from the crops. Additionally, the spacing between panel rows is wide enough that sunlight also passes between solar panel rows to reach the crops whether the system is set for normal sidereal tracking or Counter Tracking. In the normal tracking mode, the power production is optimized by having each solar panel track the sun's movement, so the wide surfaces of each panel are perpendicular to the sunlight flow.

This method of tracking and Counter Tracking is based on extensive research to optimize power generation coordinated with successful crop growth. The percentages of Tracking/Counter Tracking are varied based on the species crop that is growing beneath the solar arrays, the location, the time of day, the time of year (growing season) and the local sunlight intensity. The local sunlight intensity in a specific spectral range is measured by meters located strategically below the axis of rotation of the panels (preferably below the segment platform of the photovoltaic panel array's support structure). This provides data to a computer of the amount of “growing” sun reaching the crops below the array. Local, direct and predicted wind conditions are also provided to the computer via sensors and the internet. The computer's Counter Tracking program, with this data, performs an algorithm based on a species of crop and location specific program (computer application) to adjust a tracking command profile for the movement of the panels in the solar array to optimize Sun Sharing.

An equally important facet of the operation of this device is Sun Shading. Sun Shading is used in areas of very intense sunlight (such as desert regions) where unprotected crops are often damaged by the intense solar radiation. This occurs especially during the summer, which would otherwise be the prime growing season. For example, alfalfa which is grown in the Imperial Valley of California (Mojave Desert) typically grows and is harvested during January through September. The first of seven monthly cuts occurs in February or March. The first two monthly cuttings often have Total Digestible Nutrients (TDN) that make these cuttings certifiable for TDN, but the five cuts later in April through August are so sun damaged that they cannot be used as high TDN foodstuffs. Some are used as low-quality animal feeds and the last few cuts are used for silage. Operation of this device allows the crops to be Sun Shaded by the solar arrays. This results in many more high-TDN cuttings during each growing season. Sun Shading is accomplished by using normal sidereal tracking which shades and protects the crop(s) growing beneath the arrays from the deleterious effects of the hot, desert sunlight. Sun Shading has the additional advantage that the solar arrays produce a much higher percentage of their design power output because they are in constant tracking mode with very little Counter Tracking.

Many crops that are subject to “sunburn” can benefit from being grown in the environment provided by this device. Crops such as: peppers, tomatoes, lettuce, pumpkins, squash, cucumbers, walnuts, almonds all grow without negative sunburn impacts that often lead to significant crop loss or reductions in the quality and commercial viability of the crops.

Growing crops beneath solar arrays, has the additional advantage of reduced evapotranspiration. This means reduced water usage per unit volume of crop produced. Published studies show reduction in water usage in the 14% to 29% range for crops that are grown in controlled sunlight/shade.

To put things in perspective in the preferred solar cell array 4, the segment platforms 18 are 40 feet by 50 feet and the pilings 10 are approximately 43.5 feet long where they extend out of the agricultural field 6 for a finished height above grade of approximately 18 feet to the bottom of the segment platform 18. (Although the minimum height requirement is 12 feet.) A typical 1-megawatt electrical generation solar station will have 48 segment platforms. Alternate foundation configurations using reinforced concrete piers and/or grade beams to provide vertical and lateral support for the steel columns that support the segment platform 18 are also within the scope of this technology.

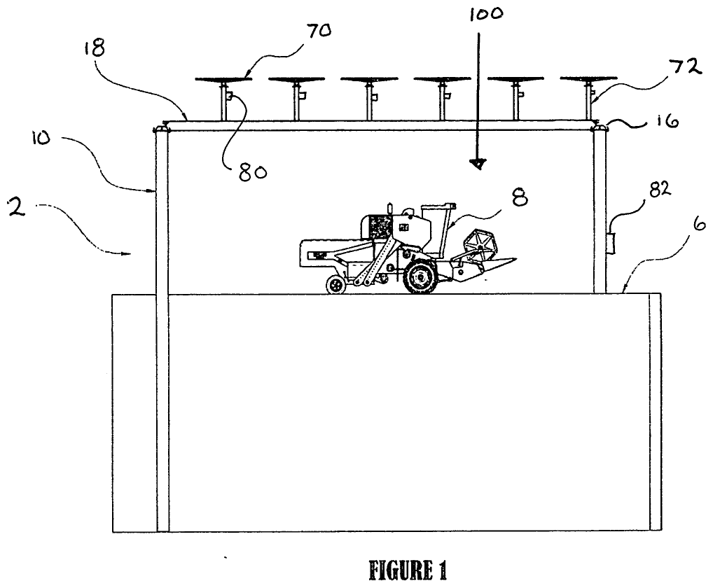

Looking at FIGS. 1, 2, 5 and 6 it can be seen that the photovoltaic panel array 4 sits atop of the segment platform 18 of the photovoltaic solar array support structure 2, which is located above an agricultural field 6, at a height to allow agricultural equipment 8 to pass underneath. The segment platform 18 is a rectangular, planar frame that has piling caps 16 at its corners (and optionally at any other support points) that are inserted into the open top ends of tubular vertical pilings 10 that have their bottom ends anchored into the ground below. The segment platform 18 is made of parallel exterior and interior running spars 22 and 21 connected to perpendicular boundary beams 20 and stiffening spars 50. (The support structure for the array 4 is detailed in U.S. patent application Ser. No. 15/949,354, filed April 10, 201 incorporated in its entirety herein and entitled “Photovoltaic Solar Array Support Structure.”)

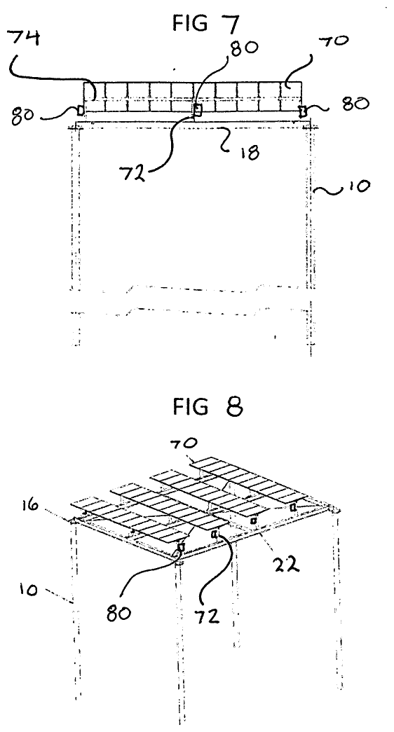

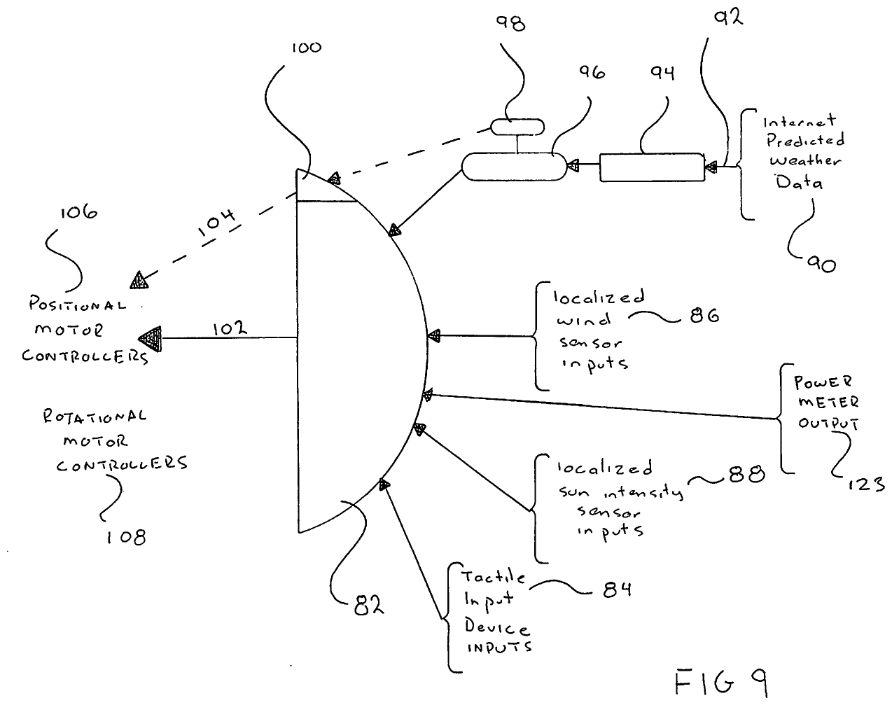

The photovoltaic panel array 4 is made of a series of rows of substantially similar vertical posts 72 mechanically affixed onto the running spars 22, and having a linear member 74 (FIGS. 7 and 8) rotateably connected across the top of each row of posts 72. The linear members 74 span the width of the segment platform 18. Onto each linear member 74 there is a row of operationally connected solar panels 70. There are horizontal positional motors 80 and their motor controllers 106 mounted on the posts 72 that are operationally connected to the linear members 74 to slowly rotate the linear member 74 and tilt the solar panel between a vertical position (sun shading) and a vertically inclined position (sun sharing). There may be horizontal positional motors 80 at each post 72 or only at one post 72 per row of solar cells. This is determined by the size of the motor 80, the length of the row, and the size or weight of the solar panels 70. These horizontal positional motors 80 are operationally connected to the photovoltaic panel array's power grid and also connected through their motor controller to the data acquisition computer 82, which are conveniently mounted at accessible locations on the support structure 2.

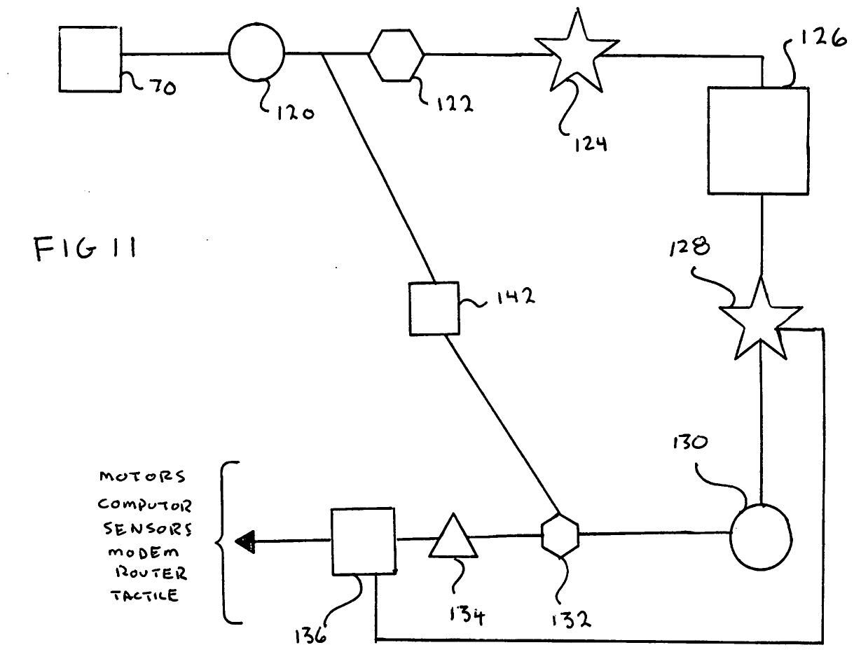

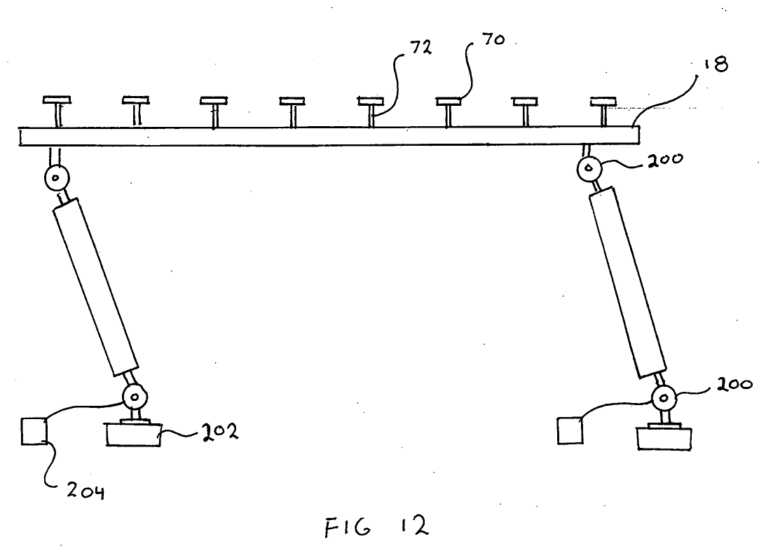

Looking now at FIG. 10 with respect to FIG. 11, a typical single photovoltaic solar array 4 and its operational components mounted on its support structure 2 can be seen and understood. On the support structure 2 is mounted solar power D/C power output meter 120 which is directly connected to the electrical output of the solar panel array 4. (This power meter is operably connected to the data acquisition computer 82.) The charge controller 142 is connected between the electrical output of the solar array and the battery bank 132. Also connected to the output of the solar panel array is the inverter 122 to which is connected first transformer 124, the output of which feeds into the main A/C power grid 126. Power drawn from the main power grid 126 is fed to second transformer 128 and then directly to the solar array's local operational power grid 136 or indirectly to the solar array's power grid 136 through the AC/DC charging unit 130 and the D/C battery bank 132 and then the rectifier 134.

The data acquisition computer 82 generates signals to initiate the operation of the horizontal positional motors 80 through their integrated motor controllers as will be discussed further herein. Since a horizontal positional motor 80 rotates a horizontally disposed linear member 74, it changes the inclination of all of the solar panels 70 in its row simultaneously. (In alternate embodiments there may be individual rotational motors incorporated into the support structure 2 for vertical rotation of the panels 70 to better track the direct impingement of the sun onto the solar panels 70. These too, are operated through their motor controllers by the data acquisition computer.)

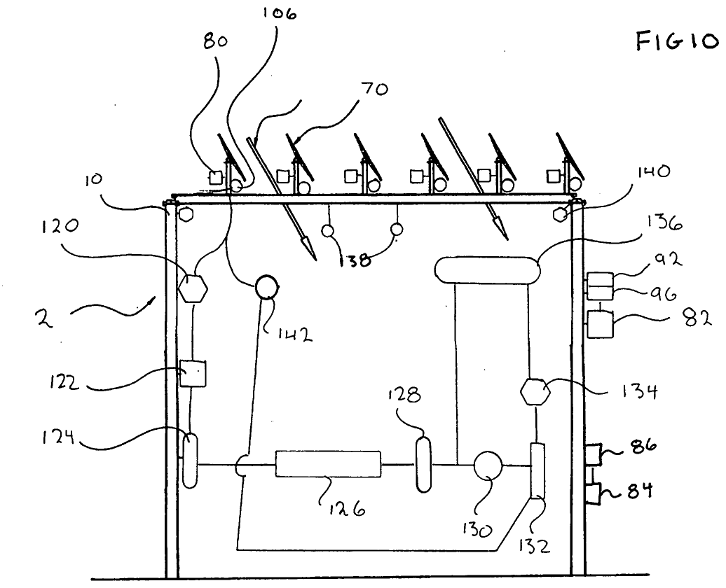

As illustrated in FIG. 9, the data acquisition computer 82 receives signals from a tactile input device 84 (such as a keyboard or a visual monitor/keyboard station), the localized wind strength (and or direction) sensor inputs 86, the localized sun intensity (PAR) sensor inputs 88 and internet weather data signals 90 via the world wide web 92 through a modem 94 and a router 96. These signals are preferably transmitted via hard wiring, although in alternate embodiments the router 96 may have a wireless transceiver (Wi-Fi or Bluetooth) that communicates with a wireless transceiver 100 in the data acquisition computer 82. The wind and sun intensity sensors may also transmit their signals wirelessly. After algorithmic analysis of the input data is performed, the data acquisition computer 82 outputs a signal (hard wired 102 or wireless 104) to the solar panel horizontal positional motor controllers 106 or the motor controllers' wireless transceivers that operates the horizontal positional motors 80, (optionally to any vertical rotational motor controllers) to tilt (optionally rotate) the solar panels 70. Lastly, there is an output signal from the solar panel DC power output meter 120 operationally connected to the data acquisition computer 82.

The solar array's local operational power grid 136 supplies the power to operate all of the solar array's components including the data acquisition computer, router, modem, wireless transceivers, rotational motors, positional motors, all sensors, and the tactile input device. It receives power in several different ways to ensure operational stability. It draws power directly from the main A/C power grid 126 or from the battery bank 132 which is supplied from both the charge controller 142 (getting D/C power from the solar panels) and the second transformer 128 (getting power from the main power grid 126). With this type of redundancy, the solar array's operational power should always be available. (FIG. 11)

Strategically mounted on the bottom of the segment platform of the support structure 2, between the rows of panels, below the axis of rotation of the panels and extending downward a distance from the mounting point, residing between the rows of solar panels is at least one sun intensity sensor 138 measuring photosynthetically active radiation (PAR) in the specific spectral range of 400 to 700 nanometers. This is the range sunlight of the electromagnetic spectrum which photosynthetic organisms such as crops are able to use in photosynthesis. These sensors determine the average PAR that is getting through to the crops growing beneath the solar arrays.

At the corners of the support structure are wind sensors 140 measuring actual wind speed and/or direction. Both the wind and sun intensity sensors are operably connected to the data acquisition computer 82 and the solar array's local operational power grid 136. The data acquisition computer 82, router 96 and modem 92 are operationally connected for data transfer as well as operationally connected to the solar array's local operational power grid 136. The data acquisition computer periodically polls the internet, extracting predicted weather forecast data (especially wind speed). With these three data input signals (as well as time and any tactile input command) the data acquisition computer algorithmically determines the proper angular position for the panels 70 to be in and sends the appropriate signals to the motor controllers 106 to drive the positional motors 80. These motors adjust the angular position of the panels.

It is to be noted that the environmental conditions such as localized high wind speed as well as certain human tactile input commands from the tactile input device, in computer application's algorithm, have priority in the adjustment of the tracking command profile for the movement of the panels. This generally is for safety concerns and to protect or service the equipment. For example, the panels will be tilted approximately 60 degrees for washing. The full up to horizontal position can take over an hour of continuous movement to accomplish. (Incidentally, the energy generation difference between the 45 degree tilted (up) position and the horizontal (parked) position is only approximately 20%.)

In future embodiments, there may be more environmental sensors incorporated such as temperature sensors, rain sensors, humidity sensors, wind direction, ground moisture and the like operationally connected to the data acquisition computer 82 to provide input data used by the counter tracking program. These will be important as the algorithms and applications are developed further to consider more of the specific crop growth factors. Although, at this time the type of crop species, local sun intensity, location, time of year, timing of crop species growing cycle are all factors considered and evaluated in the algorithmic determination of panel position, future algorithms will become more sophisticated and look at many more crop growth related parameters.

Optionally, there may also be a solar position tracking device mounted on the structure as is well known in the field, that can be used to provide a signal to the data acquisition computer 82 related to the sun's position. Presently without such a system, the sun's position used in the counter tracking program will be determined from a relational database of sun positions vs times and dates stored in the data acquisitions memory or accessible from the internet. These environmental inputs are used in the algorithm as they provide information used to minimize the angle of incidence between the incoming sunlight and the solar panel.

With respect to the erection of the array, with the pilings 10 erected, the segment platforms 18 are assembled on the ground and the linear members 74 with rows of solar panels 70 with their wiring, horizontal positional motors 80 and their motor controllers 106 are operationally mounted on the posts 72. The sensors and data acquisition computer 82 preferably are mounted on the running spars 22, the boundary beams 20 or the pilings 10. In this way, a segment platform 18 can be lifted by crane or other jacking system to above the structure 2 and the piling caps 16 connected with mechanical fasteners to the exterior corners of the segment platform 18 such that and the piling inserts 26 of the piling caps 16 may be lowered into the open top ends of the pilings 10 and the structure assembly completed. Certain components will be mounted low on the pilings so as to be accessible for routine maintenance and repair.

FIG. 12 shows a representative diagram of a hinged platform assembly. This is an alternative to lifting the segment platform 18 by adding hinge joints incorporated into hinge joint assemblies 200 at the foundation base 202 of each piling and at each pile cap to allow the segment platform 18 to be built on the ground as described above, then pivotally raised to its operational elevation using adjustable jacks either hydraulically or electrically driven. Hydraulic pumps 204 are shown driving internal motors and gearing arrangements within the hinge joint assemblies 200. The segment platform 18 can then be moved laterally (at a varying height from the ground) by the adjustable jacks, to allow the sunlight to pass through the spaces between the solar panel rows to increase or decrease the solar energy that reaches the crops growing beneath. The solar array on top of the platform will operate identically to that of the preferred embodiment in that the solar panels of the solar panel array are still computer controlled and tiltable. This embodiment just adds the tiltable feature of the platform and the ability to change the horizontal position of the platform. (As the platform is tilted upward, both its vertical and horizontal positions change. The novel feature of this type of design is that it allows much greater flexibility in the method of sun sharing.)

In conjunction with the optimized solar panel movement (counter tracking) there are additional optimization devices and techniques that allow the growth of various crops in climates previously too hot and dry to support crop growth, by reducing crop evapotranspiration. These include any combination of specially designed solar panels 70 and specific spacing of the solar panels in the solar panel array 4.

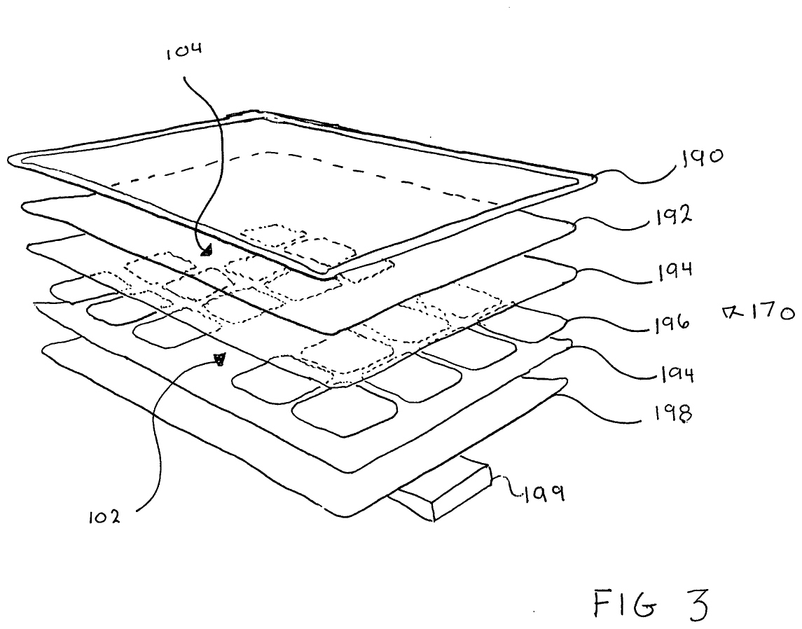

Looking at FIG. 3 an optimized solar panel 170 for use in sun shading and sun sharing may be best seen. The optimized solar panel 170 has an enclosure with an upper frame 190 attached to a sheet of translucent material 192 (such as glass) under which is sandwiched an encapsulant 194 (first layer), a series of solar cells 196 (arranged in an interrupted repeating pattern array), the individual solar cell wiring (not illustrated for visual clarity) going to the junction box, and an encapsulant 194 (second layer), supported on a back sheet 198 (which may or may not have a lower frame attached that is substantially similar to the upper frame) through which extends the electrical connections for the junction box 199. (Newer solar panels may have solar cells with different designs that function without the external layers of encapsulant 194.) The enclosure has sides (not illustrated for visual clarity) that connect to the frame and the back sheet 198 (with or without an attached frame) so as to houses all of the remaining components—the solar cells, the encapsulant and the wiring. The junction box 199 is affixed to the housing.

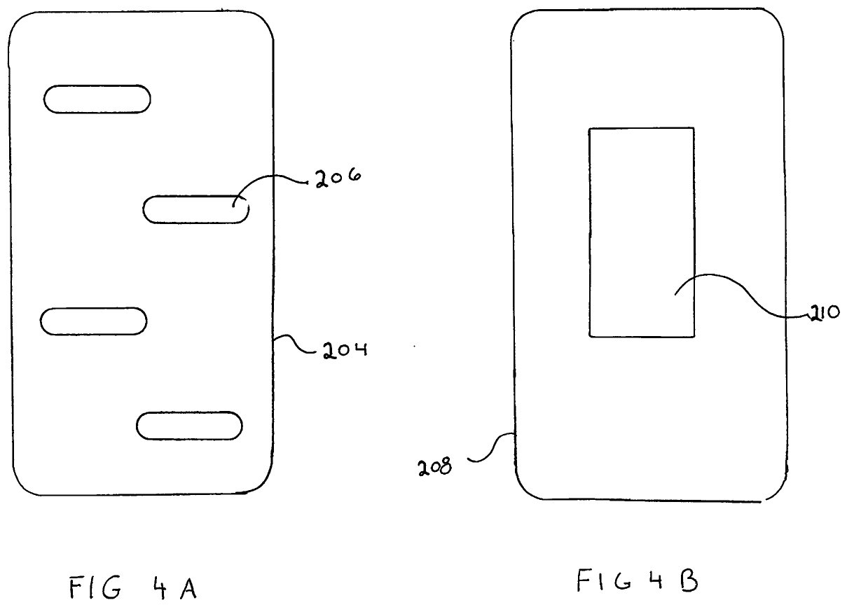

FIG. 4A shows a first alternate embodiment modified solar panel 204 wherein through slots or perforations 206 have been cut through all of the layers of the solar panel so as to allow the unhampered passage of sunlight. These can vary in size and number with the critical feature being the total area of sunlight passage. FIG. 4B shows a second embodiment modified solar panel 208 where the solar cells are arranged around a single central orifice 210 through the solar panel. The difference being that with more smaller perforations, the light beneath the cell is more diffuse but has less direct shaded areas. FIG. 6 shows a single modified solar panel with a slot 206 therein that can pass limited sunlight 110 to the crops below. A standard solar panel 70 that cannot pass sunlight through its enclosure is seen at the opposite corner of the segment 18.

Generally, each standard solar panel has a repeating pattern array of individual solar cells arranged in a generally rectangular enclosure. The modified solar panels differ from a standard solar panel in that they have an interrupted repeating patterned array of solar cells which may be from empty rows or sections of solar cells 202 or from removed single solar cells 204. Since the sunlight must be able to pass through the solar panel with as little attenuation as possible, the modified solar cells accomplish this in two ways. First, the enclosure is made translucent above and below the area of the removed solar cells with a back sheet 198 that is also translucent, and the encapsulant is also removed above and below the vacant solar cell sites. (FIG. 3) Second, there are complete voids in the enclosure, where there is an orifice through the entire solar panel. (FIG. 4) These orifices can be slots or large voids where the solar cells are removed, disrupting their repeating pattern or they can be a series of smaller perforations between adjacent solar cells. This allows the sun to pass through the solar panel with minimal intensity losses or attenuation. Alternately, a translucent solar cell media may be used, in which case there is no need for the elimination of select solar cells to develop interstitial voids in repeating pattern of solar cells in the solar panel.

In other embodiments, (not illustrated) adjacent solar cells of the repeating pattern array of solar cells may be spaced sufficiently apart to accommodate a repeating pattern of orifices throughout the solar panel without the need to interrupt the repeating pattern array of solar cells. This gives a more diffuse lighting profile beneath the solar panel. Use of such panels may or may not require counter tracking.

The Counter-Tracking program's algorithm will also take into consideration the percentage of optimized solar panels to standard solar panels in the array for determination of the actual photosynthetically active radiation reaching the crops beneath.

The counter tracking for each photovoltaic panel array 4 is optimized for its location and the crop associated under it. The amount of light or shade (exposure time and intensity) the crops receive and when this occurs throughout the day, the solar year and the crop cycle, for the optimized growth of different types of crops across a growing season is determined by agricultural scientists. This is input to the discrete algorithm of the counter tracking program to be used for that crop at that location. The input from any of the environmental sensors along with the sun's position is algorithmically analyzed by the discrete counter tracking program to determine and generate the signal to the horizontal positional motors to tilt the solar panels. Counter-Tracking leads to controllable growing conditions that can vary the productivity of the crops, control when some crops flower and bud, etc. There are also overriding dangerous environmental conditions such as high wind loads that will cause the counter tracking program to rotate the solar panels to a horizontal position.

FIG. 1 shows the panels in their typical position at solar noon (with the sun directly overhead). Here the solar panels 70 have been rotated for maximum power generation and the crops get maximum shading. It shows solar panels 70 allowing limited sunlight 100 to pass between the spaces between solar panel rows. This type of operation may use either standard or modified solar panels positioned to also allow a certain percentage of sunlight to pass through the panel face to the ground below.

In the alternative embodiment using the hinge-erection procedure, the sunlight passing between the spaces between solar panel rows can be controlled by the lateral movement of the solar panel rows (Counter-Tilting) that are enabled by activating the adjustable jacks described above.

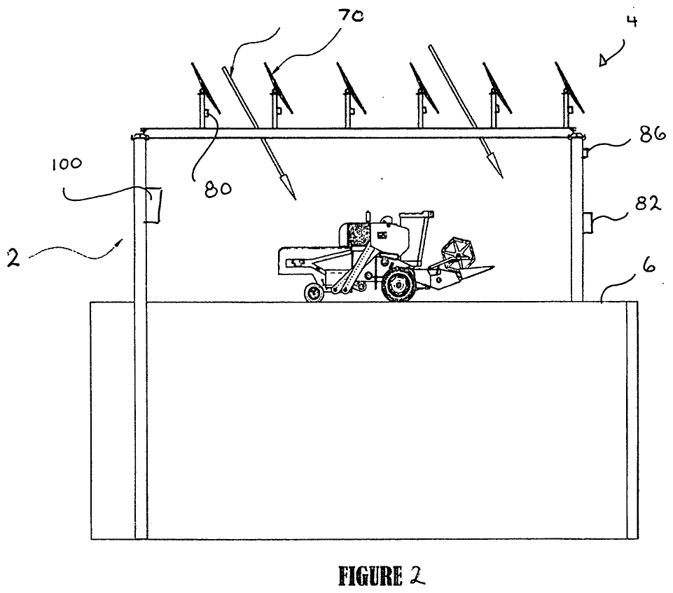

FIG. 2 is an illustration of the dynamic Counter-Tracking method. It shows the panels in their inclined position to reduce the angle of inclination of the sunlight upon the solar panel faces and increase solar efficiency. This type of operation may use either standard or modified solar panels. This allows maximum sunlight 100 to reach the crops below by passing through the space between rotated panels edges. During certain periods of the day (typically in the early morning and late afternoon), the panels are positioned to be parallel to the path of the sun's rays. The panels use a typical sidereal tracking algorithm that is modified by approximately 90 degrees to track the sun's movement and to provide the least amount of shading of crops being grown beneath the arrays. Sunlight 100 passes by the narrowest edge of the panel to minimize shading of crops and maximizing sunlight that reaches the crops below. During this period of time, electrical power generation is reduced and crop irradiation is maximized. Agricultural research and experimentation led to the development of Counter-Tracking algorithms that vary from one crop to the next. These algorithms are dependent upon latitude, weather, the crop's need for intense sunlight, the type of crop, etc.

An additional modality is to have the solar panels spaced in each row on the segment 18 so that sunlight can also pass through spaces between each panel row to the ground below. By Counter-Tilting, moving the segment 18 laterally using adjustable jacks described above, the sunlight passing through the spaces between panel rows can be controlled to provide more or less solar irradiation to specific areas of crops growing beneath.

Solar/Agricultural research has demonstrated that certain crops that can otherwise be damaged by intense, direct sunlight actually grow with higher quality, better yields, and they produce higher levels of total digestible nutrients when the crops can be “shielded” from the all-day high intensity sunlight, especially during the summer growing season, through the use of Counter-Tracking. Counter-Tracking allows the farmer and power producer to cooperatively determine and create the optimal sun sharing and/or sun shading conditions for each crop by varying the Counter-Tracking program's algorithms that control the sun sharing/sun shading percentages for that crop. During experimental testing, reduction in evapotranspiration has been observed to create water savings of 14% to 29% using the disclosed techniques. This technology is particularly useful in areas with extremely high temperatures and/or with limited water access.

The additional advantage of an infinitely variable Counter-Tracking methodology to provide sun sharing between crop growth and power generation; is the additional ability to switch to 100% normal tracking when agricultural fields are fallow (between crop plantings). This maximizes the power generation on farmland when crops are not present.

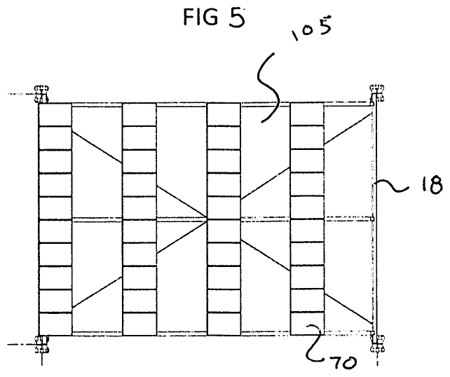

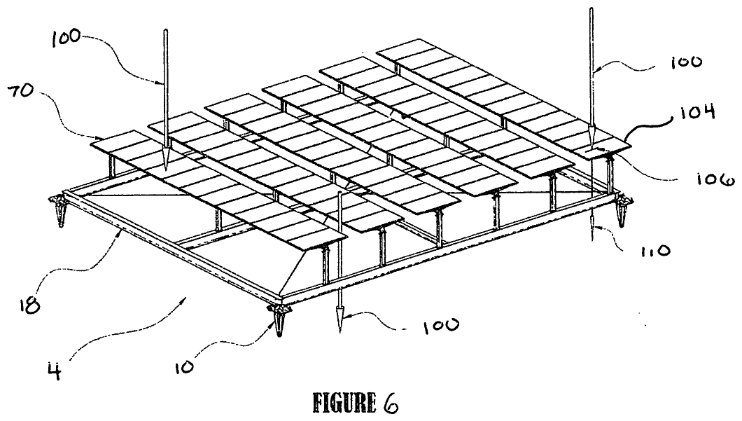

The present invention allows sunlight to impinge on agricultural land below by a static method or a dynamic method. In the static method, the panels are mounted in a manner that leaves spaces 105 between the panels thus allowing sunlight through to the crops below (FIG. 5) or a modified solar panel is used that allows parcels of sunlight to pass through the solar panels via orifices, perforations or a translucent material construction.

In the dynamic method (hereinafter “Counter-Tracking”), a standard solar panel or a modified version of solar panel are periodically rotated or otherwise moved aside at appropriate intervals during the sun's daily cycle thus allowing sunlight to bypass the panels and pass through to the crops beneath the solar array. (FIGS. 1 and 2)

In the preferred embodiment of a photovoltaic panel array the following steps to apply sun shading and sun sharing are employed via the Counter-Tracking program of the data acquisition computer:

1. From first daylight for 3 hours more or less, the panel array is positioned to allow maximum sunlight to reach the ground and the crops being grown beneath the array, to facilitate crop growth. This typically causes the sunlight to focus on the narrow edge of the solar panels, rather than on the wide face of the panel (which would block sunlight from reaching the ground and crops below).

2. Thereafter, for 8 to 10 hours more or less depending upon seasonal variations in sunlight, the panel array is re-positioned to conventional solar tracking to maximize power output. This allows the sunlight to focus on the wide face of the solar panels as it would in a normal tracking environment, while providing limited shade to the crops beneath.

3. During conventional tracking, the end-spacing between panel rows also allows solar energy to pass through to the crops beneath the array for several hours on either side of solar noon (when the sun is directly above the array). This timing supports 100% solar pass-through via the openings between panel rows, while also generating 100% solar power generation. The sidereal movement of the sun causes movement of the sunlight pattern to provide high energy solar irradiation to the crops below. This solar pass-through can be augmented by Counter-Tilting of the solar platform.

4. Thereafter for three hours more or less prior to sunset, the panel array is again re-positioned in Counter-Tracking mode to facilitate crop growth.

5. Thereafter, following sunset, the panels are re-positioned to a horizontal condition until dawn to resist wind loads during the night. The Counter-Tracking, Normal Tracking, Counter Tracking panel positioning is repeated daily and can be fine-tuned to improve crop growth and power generation as required.

The novel aspects of the method of producing solar power while allowing sufficient sunlight to pass by and/or through motorized tiltable solar arrays to the crops growing beneath the solar arrays can be seen in the steps of the preferred method below.

1. Install an array of motorized tiltable solar panels over a crop field, on a structure having a platform raised a minimum of eight feet above the ground where the solar panels are tilted about an axis of rotation by motors.

2. Install at least one sunlight intensity meter below the axis of rotation of the solar panels that provides sunlight intensity data signals to a connected computer.

3. Install at least one localized wind strength meter that provides wind strength data signals to the connected computer.

4. Operatively connect an internet with a site providing predicted weather data to the computer.

5. Operatively connect a tactile input device to the computer to provide user input instructions.

6. Provide solar positional data to the computer.

7. Operably connect the computer to the motors, where the computer performs a crop specific algorithmic calculation using: sunlight intensity data from the sunlight intensity meters, wind strength data from the wind strength meters, predicted weather data from the internet; sidereal tracking solar position data and user input instructions to tilt the solar panels for efficient electrical generation and crop growth.

Although optimally the platform of the support structure will be approximately 15-18 feet off of the ground, it need be only high enough to allow the type of mechanized equipment used on the underlying crops to safely work, which sets the minimal height of 8 feet. Also, optimally the solar positional data provided to the computer will be sidereal tracking solar position data, although solar tracking data determined through other tracking systems may be substituted.

Many other embodiments are possible depending upon, but limited to the following parameters: land latitude, weather (e.g. sunny, cloudy, rain); type of crop; growing season; irrigation systems and levels; stage of crop growth; and scheduled or unscheduled agricultural work such as plowing, seeding, fertilizing, pest control, weed control & harvesting.

The basic method need not use computers or motors and may have as few steps as follows:

1. Installing a tiltable solar panel array over a crop field, on a structure having a platform raised a minimum of eight feet above the ground; said solar panels selected from the group of solar panels consisting of solar panels that are partially transparent, solar panels that are translucent or solar panels that are slotted;

2. Determining an optimizing balance of sunlight intensity on said solar panel array and on said crops beneath said solar panel array to produce solar power and crop growth;

3. Tilting said tiltable solar panel array to a horizontal position of determined angle and for a determined period of time to adjust and maintain the sunlight intensity on said solar panel array and on said crops to meet said optimizing balance of said sunlight intensity.

The basic method with the hinge erection platform (without the use of computers) may have as few steps as follows:

1. Installing a tiltable solar panel array on a support structure over a crop field, on a tiltable structure having a platform that moves laterally when raised above the ground; said solar panels selected from the group of solar panels consisting of solar panels that are partially transparent, solar panels that are translucent or solar panels that are slotted;

2. Determining an optimizing balance of sunlight intensity on said solar panel array and on said crops beneath said solar panel array to produce solar power and crop growth;

3. Tilting said tiltable solar panel array to a horizontal position of determined angle and for a determined period of time to adjust and maintain the sunlight intensity on said solar panel array and on said crops while tilting the structure to laterally change the lateral position of the platform to meet said optimizing balance of said sunlight intensity.

The present invention advances the art of electricity generation using standard solar panels, optimized solar panels that permit sunlight to pass through or around them or by a combination of both types of panels. This allows utilizing already existing agricultural lands, while coexisting with minimal interference with the agricultural uses of the land. Research has demonstrated that certain crops that can otherwise be damaged by intense, direct sunlight actually grow with higher quality, better yields, and they produce higher levels of Total Digestible Nutrients when the crops can be “shielded” from the all-day high intensity sunlight, especially during the summer growing season, through the use of Counter-Tracking. Counter-Tracking allows the farmer and power producer to cooperatively determine and create the optimal Sun Sharing conditions for each crop by varying the Counter-Tracking algorithms that control the Sun Sharing percentages for that crop. During experimental testing, reduction in evapotranspiration has been observed to create water savings of 14% to 29% using these Sun Sharing techniques. This technology is particularly useful in areas with extremely high intensity sunlight such as deserts, that would otherwise preclude farming operations.

Since each counter tracking program is a specialized program taking into consideration the location and crops, to provide Sun Sharing between crop growth and power generation; there is the additional ability to switch to 100% normal tracking when agricultural fields are fallow (between crop plantings). This maximizes the power generation on farmland when crops are not present.

The present invention advances the art of solar panel electricity generation by using already existing agricultural lands or other disadvantaged or restricted lands, coexisting with uses of these lands with minimal intrusion. The same system may be utilized on a support structure utilizing longer span beams and structural members than disclosed in the U.S. patent application Ser. No. 15/949,354 titled “PHOTOVOLTAIC PANEL ARRAY SUPPORT STRUCTURE”.

While certain features and aspects have been described with respect to exemplary embodiments, one skilled in the art will recognize that numerous modifications are possible. In the way of an example, the number of interior running spars may exceed one and the number of stiffening spars may exceed two or be reduced to one as numerous segment interior geometric configurations may be utilized. The mass of the solar arrays supported and the overall size of the segment will dictate the number of additional interior supports that are needed. In a further example, the support structure may be held in its configuration raised above an agricultural field by as few a one piling centrally located. It will be appreciated that the invention is intended to cover all modifications and equivalents within the scope of the following claims.

Having thus described the invention, what is claimed as new and desired to be secured by Letters Patent is as follows:

1. A method of producing solar power while allowing sufficient sunlight to pass by and/or through motorized tiltable solar panel arrays to crops growing beneath the solar arrays, comprising the steps of:
1. Installing an array of tiltable solar panels over a crop field, on a structure having a platform raised a minimum of eight feet above the ground;
2. Installing an algorithm in a computer, said algorithm computing solar panel positions for said solar panels at specific times for optimizing power production and crop growth;
3. Installing at least one sunlight intensity meter below an axis of rotation of said solar panels that provides sunlight intensity data signals to said computer;
4. Installing at least one localized wind strength meter that provides wind strength data signals to said computer;
5. Operatively connecting said computer to an internet with a site providing local predicted weather data and local sidereal tracking solar position data for that local; and
6. Performing a crop specific algorithmic calculation by said computer considering said sunlight intensity data signals, said wind strength data signals, said predicted weather data and said sidereal tracking solar position data to determine a horizontal tilt position for a period of time for said solar panels to optimize power production and crop growth.
7. Tilting said solar panels as determined by said algorithmic calculation.

2. The method of producing solar power of claim 1 comprising the further steps before step 7:
1. Connecting said solar panels to at least one motor that tilts said solar panels to a position at a time as determined by said algorithmic calculation;
2. Operably connecting said computer to said at least one motor, where said computer provides said crop specific algorithmic calculation to said at least one motor,
3. Tilting said solar panels with said at least one motor.

3. The method of producing solar power of claim 2 wherein said solar panels are selected from the group of solar panels consisting of solar panels that are partially transparent, solar panels that are translucent or solar panels that are slotted.

4. The method of producing solar power of claim 1 wherein said crop specific algorithmic calculation utilizes crop specific data selected from the group of crop specific data consisting of the plant species and time of the crop species specific growing season.

5. A method of producing solar power while allowing sufficient sunlight to pass by and/or through tiltable solar panel arrays to crops beneath, comprising the steps of:
1. Installing a tiltable solar panel array over a crop field, on a structure having a platform raised a minimum of eight feet above the ground; said solar panels selected from the group of solar panels consisting of solar panels that are partially transparent, solar panels that are translucent or solar panels that are slotted;
2. Determining an optimizing balance of sunlight intensity on said solar panel array and said on said crops beneath said solar panel array to produce solar power and crop growth;
3. Tilting said tiltable solar panel array to a horizontal position of a determined angle and for a determined period of time to adjust and maintain the sunlight intensity on said solar panel array and said on said crops to meet said optimizing balance of said sunlight intensity on said solar panel array and said on said crops beneath said solar panel array to produce solar power and crop growth.

6. The method of producing solar power of claim 5 wherein said determining an optimizing balance of sunlight intensity on said solar panel array and on said crops beneath is based on an algorithm considering local environmental data and crop specific data.

7. The method of producing solar power of claim 6 wherein said local environmental data is selected from the group consisting of local wind strength, local sunlight intensity below said solar panel array, sidereal tracking solar position data and localized predicted weather data.

8. The method of producing solar power of claim 7 wherein said crop specific data is selected from the group consisting of plant species and time of the crop species specific growing season.

9. A method of producing solar power while allowing sufficient sunlight to pass to crops beneath, comprising the steps of:
1. Installing a tiltable solar panel array on a tiltable support structure over a crop field, said tiltable support structure having a platform that moves laterally when raised above the ground;
2. Determining an optimizing balance of sunlight intensity on said solar panel array and on said crops beneath said solar panel array to produce solar power and crop growth;
3. Tilting said tiltable solar panel array to a horizontal position of a determined angle and for a determined period of time to adjust and maintain the sunlight intensity on said solar panel array and on said crops while tilting said support structure to change the lateral position of the platform to meet said optimizing balance of said sunlight intensity on said solar panel array and on said crops beneath said solar panel array to produce solar power and crop growth.

10. The method of producing solar power while allowing sufficient sunlight to pass to crops beneath of claim 9 wherein said solar panels are selected from the group of solar panels consisting of solar panels that are partially transparent, solar panels that are translucent or solar panels that are slotted.
